(19) United States
(12) Patent Application Publication
(10) Pub. No.: US 2014/0222527 A1
(43) Pub. Date: Aug. 7, 2014

(54) APPARATUS, SYSTEM, AND METHOD FOR OIL AND GAS BENCHMARKING

(71) Applicant: Transzap, Inc., Denver, CO (US)

(72) Inventor: Jimmy L. Allison, Wheat Ridge, CO (US)

(73) Assignee: Transzap, Inc., Denver, CO (US)

(21) Appl. No.: 14/175,844

(22) Filed: Feb. 7, 2014

Related U.S. Application Data
(60) Provisional application No. 61/762,086, filed on Feb. 7, 2013.
(60) Provisional application No. 61/817,597, filed on Apr. 30, 2013.

(51) Int. Cl. G06Q 10/06

(52) U.S. Cl. CPC G06Q 10/06393
USPC 705/7.39

(57) ABSTRACT

Implementations described and claimed herein address the foregoing problems, among others, by providing apparatuses, systems, and methods for correlating aggregated production and revenue data with aggregated cost and expense data. In one implementation, a dataset corresponding to a plurality of producing wells is received. The dataset includes revenue and production data and expense and cost data. The revenue and production data is aggregated. The revenue and production data is aggregated for a subset of the plurality of producing wells. The subset corresponds to one or more geographical locations. The cost and expense data is aggregated. The cost and expense data is aggregated for the subset. The aggregated revenue and production data and the aggregated cost and expense data is anonymized to remove proprietary and confidential information. The anonymized revenue and production data with the anonymized cost and expense data is correlated based on a production date range.

### CROSS-REFERENCE TO RELATED APPLICATIONS

The present application claims priority under 35 U.S.C. §119 to U.S. Provisional Application No. 61/762,086, which was filed Feb. 7, 2013 and entitled “Apparatus, System, and Method for Oil and Gas Benchmarking,” and to U.S. Provisional Application No. 61/817,597, which was filed Apr. 30, 2013 and entitled “Apparatus, System, and Method for Oil and Gas Benchmarking.” Each of the aforementioned applications is hereby incorporated by reference in its entirety into the present application.

### TECHNICAL FIELD

Aspects of the present disclosure relate to data aggregation and analysis as well as benchmarking services, among other functions, and more particularly to the generation of oil and gas performance metrics.

### BACKGROUND

Benchmarking is often utilized to compare performance metrics of a business or a location to industry, regional, or other standards. Such performance metrics provide insight into activity trends and may be used for comparative or economic analysis, decision making, and planning. However, some industries, like the oil and gas industry, involve a tremendous amount of complex information. For example, in the oil and gas industry, one month may produce distribution details for hundreds of thousands of owners, representing hundreds of thousands of wells across the United States. This amounts to billions of dollars in transactions and tens of millions of lines of data per month. Further, production and revenue data and cost and expense data are generally collected and stored separately for accounting purposes. As such, it is challenging to aggregate and correlate data for analysis in the oil and gas industry and similar industries. These difficulties are further exacerbated by the highly confidential nature of oil and gas information. Specifically, individual well, operator, and owner information is proprietary, making it challenging to obtain data and generate useful benchmarks.

It is with these observations in mind, among others, that various aspects of the present disclosure were conceived and developed.

### SUMMARY

Implementations described and claimed herein address the foregoing problems, among others, by providing apparatuses, systems, and methods for correlating aggregated production and revenue data with aggregated cost and expense data. In one implementation, a dataset corresponding to a plurality of producing wells is received. The dataset includes revenue and production data and expense and cost data and is stored in one or more databases. The revenue and production data is aggregated using at least one processor. The revenue and production data is aggregated for a subset of the plurality of producing wells. The subset corresponds to one or more geographical locations. The cost and expense data is aggregated using the at least one processor. The cost and expense data is aggregated for the subset of the plurality of producing wells. The aggregated revenue and production data and the aggregated cost and expense data is anonymized using the at least one processor to remove proprietary and confidential information. The anonymized revenue and production data with the anonymized cost and expense data is correlated based on a production date range using the at least one processor. The correlated data is output.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example benchmarking system, including a benchmarking application running on a computer server or other similar device coupled with a network, for providing aggregated production and revenue data and aggregated cost and expense data, for generating performance metrics, and correlating the data.

FIG. 2 shows an example user interface generated by the benchmarking application, the user interface being displayed in a browser window of a computing device and displaying a window for inputting search criteria;

FIG. 3 displays performance metrics on the user interface;

FIG. 4 illustrates example operations for determining operating margins per unit using production and revenue data and cost and expense data; and

FIG. 5 is an example of a computing system that may implement various systems and methods discussed herein.

### DETAILED DESCRIPTION

Aspects of the present disclosure involve apparatuses, systems, and methods for correlating aggregated production and revenue data and aggregated cost and expense data. In one particular aspect, a benchmarking application aggregates production and revenue data and cost and expense data, each by geographical location, which may be, for example, one or more countries, regions, states, counties, basins, fields, or other geographical areas.

In another aspect, the benchmarking application removes proprietary or otherwise confidential information from the aggregated and/or averaged datasets. Specifically, a user will be unable to obtain information relating to individual wells, operators, owners, or other confidential information. Anonymized production and revenue data and/or cost and expense data for one or more geographical locations over a given time period is thus provided. The benchmarking application combines or otherwise correlates the production and revenue data with the cost and expense data. The correlated data, the anonymized aggregated production and revenue data, or the anonymized aggregated cost and expense data may be disseminated in a variety of manners to vendors or other interested parties. Moreover, the system may generate performance metrics for the aggregated and/or correlated data.

In still another aspect, the benchmarking application generates performance metrics from the aggregated data to provide insight into historical, current, and/or future trends that may be used for comparative or economic analysis, decision making, planning, etc. For example, a prospector may utilize the benchmarking application to determine sales volumes, values, prices, taxes, and deductions for a specified region for economic analysis, trends, planning, or other purposes. The generated performance metrics provide visibility and insight to the various oil and gas owners, operators, vendors, analysts, buyers, sellers, traders, and other interested parties into revenue and/or cost activities and trends, as well as into regional and industry standards and expectations. For example, an operator may utilize the benchmarking application to compare revenue and/or cost data for geographically adjacent wells to determine whether pricing is appropriate for the location.

In yet another aspect, the benchmarking application provides for viewing, searching, reporting, printing, and/or downloading the aggregated data and performance metrics. The information may be presented in various manners, such as tables or graphs, or displayed for each performance metric over time for selected geographical areas. The benchmarking application provides insight into revenue and/or cost past and current activity and trends. Further, the production and revenue data and the cost and expense data may be used to extrapolate future performance metrics.

The various apparatuses, systems, and methods disclosed herein provide for correlating aggregated production and revenue data and aggregated cost and expense data, as well as for generating performance metrics using aggregated and/or correlated data. The example implementations discussed herein reference the oil and gas mineral industry. However, it will be appreciated by those skilled in the art that the presently disclosed technology is applicable to other industries and data.

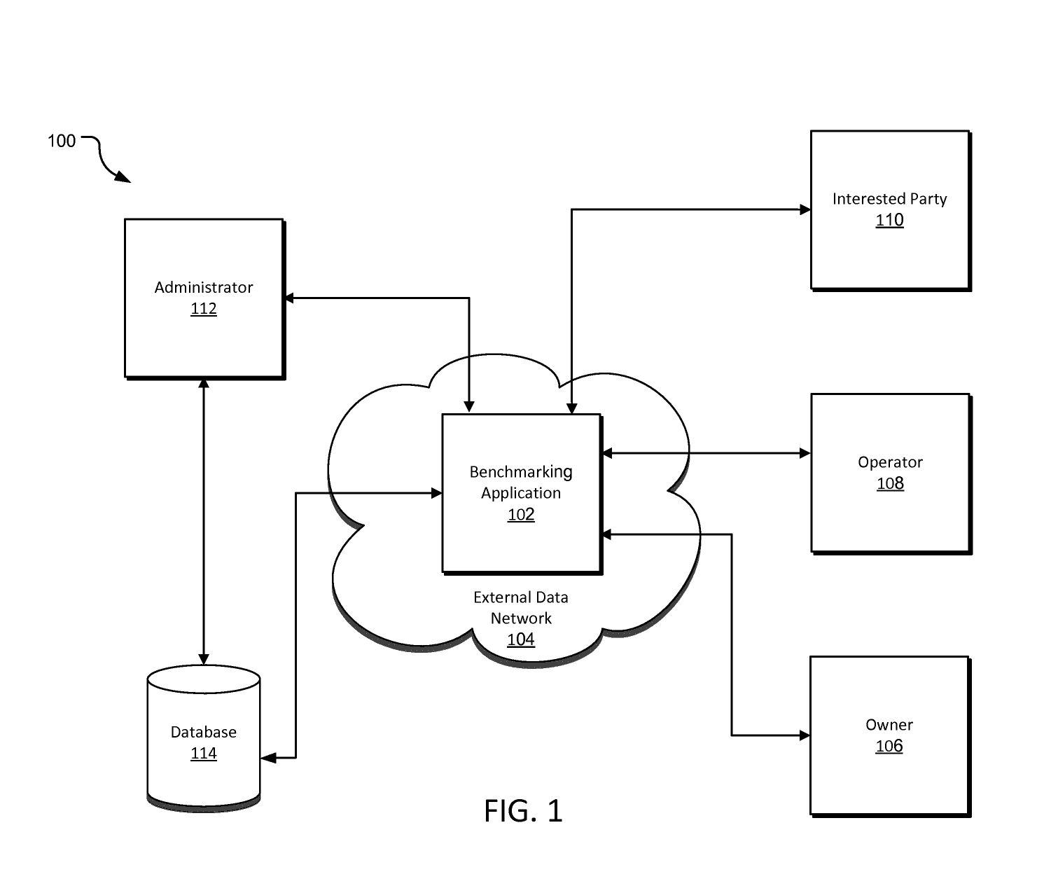

Referring to FIG. 1, an example benchmarking system 100 for correlating aggregated production and revenue data and aggregated cost and expense data is shown. In one implementation, a user requests or searches for production and revenue data and/or cost and expense data using a benchmarking application 102 via a network 104 (e.g., the Internet).

In one implementation, the user is a party associated with the oil and gas industry, such as an owner 106, an operator 108, or another interested party 110. Generally, the owner 106 is a party retaining an interest under an oil, gas, and/or mineral lease, and the owner 106 receives revenue from this interest based upon a value of a percentage of the oil, gas, and/or minerals produced from the lease. The owner 106 may be a royalty owner (i.e., an owner that owns an interest in the oil, gas, or other minerals and receives revenue from this interest), a working interest owner (i.e., an owner that shares in the expense of operating the well and in the revenue obtained), an overriding interest owner (i.e., an owner of proceeds from production but not of the oil, gas, or minerals that is generally created from a working interest conveyed cost free), or other type of owner.

The operator 108 operates a well owned by the owner 106 pursuant to a lease and/or assignment. The operator 108 captures revenue from the leased oil, gas, and/or minerals, pays a percentage of that revenue to the royalty owner pursuant to the lease terms, and shares any remaining revenue with the working interest owner and overriding owner. The operator 108 may use the benchmarking application 102, for example, to obtain insight into the overall economics for an average barrel of oil or MCF of gas produced to determine whether operating in a specific geographic location will be a good return on capital over time. The interested party 110 is any party interested in production and revenue data, cost and expense data, performance metrics, trends, forecasts, or activities associated with oil and gas revenue and/or costs, such as vendors, analysts, marketers, prospectors, commodity buyers/sellers, traders, or other businesses or parties. An administrator 112 provides various management, transaction, registration, and support services, among other functions, for the interest owners 106 and the operators 108.

The network 104 is used by one or more computing or data storage devices (e.g., one or more databases 114) for implementing the benchmarking system 100. The user (e.g., the owner 106, the operator 108, or the interested party 110) and/or the administrator 112 may access and interact with the benchmarking application 102 using a user device communicatively connected to the network 104. The user device is generally any form of computing device capable of interacting with the network 104, such as a personal computer, terminal, portable computer, mobile device, a tablet, a multimedia console, etc.

In one implementation, the network 104 includes a server hosting a website or an application that the user may visit to access the benchmarking application 102. The server may be a single server, a plurality of servers with each such server being a physical server or a virtual machine, or a collection of both physical servers and virtual machines. In another implementation, a cloud hosts one or more components of the benchmarking system 100. The user devices, the server, and other resources connected to the network 104 may access one or more other servers to access to one or more websites, applications, web services interfaces, storage devices, computing devices, or the like. that are used to generate benchmarking information. The server may also host a search engine that the benchmarking system 100 uses for accessing, searching for, and modifying production and revenue data, cost and expense data, performance metrics parameters, and/or other benchmarking information.

As can be understood from FIG. 1, production and revenue data and/or cost and expense data may be received from the owner 106, the operator 108, and/or other sources via the network 104 and stored in the database 114. Often, production and revenue data is collected and stored separately from cost and expense data. In one implementation, the owner 106 and/or the operator 108 each have an account storing revenue and production data and/or cost and expense data for one or more of their producing wells, including revenue data exchanges between the operators 108 and the owner 106, in the database 114. In some implementations, the benchmarking application 102 may also send one or more communications to various data sources to obtain current revenue, production, cost, and/or expense data and update the database 114. For example, in the United States, many states and/or counties require the operators 108 to report the amount of production for wells they operate on a regular basis (e.g., monthly, quarterly, etc.). This reported information is available in public state records, which may be accessed to update the database 114.

Further, various third parties may obtain and compile information corresponding to the geographic location and/or production of the wells. Data may be obtained or purchased from these third parties and stored in the database 114. In other implementations, the user or various other parties may manually enter or report revenue, production, cost, and/or expense data into the benchmarking application 102. Such manual entry may be used for example, when the source of the data does not provide a data feed to the database 114. As data is input or received into the benchmarking application 102, the network 104, and/or the database 114, the benchmarking application 102 updates the revenue and production data and the cost and expense data in substantially real time.

The benchmarking application 102 parses the revenue and production data stored in the database 114 and aggregates the data to derive geographical location net values by providing total production (e.g., by product, price, and revenue) less tax and other deductions. In one implementation, the benchmarking application aggregates the revenue and production data by geographical location, which may be, for example, one or more countries, regions, states, counties, basins, fields, or other geographical areas. A basin is a geologic area, which may contain one or more fields. A basin may cross county lines, state lines, or other jurisdictional boundaries. A field is a sub-location within a basin often consisting of a concentration of wells. A user may search and query combinations of production and revenue parameters as described herein over time to derive geographical location net values.

Similarly, the benchmarking application 102 parses the cost and expense data stored in the database 114 and aggregates the data to provide oil and gas production values associated with finding, acquiring, developing, completing, equipping, and producing. In one implementation, the benchmarking application 102 aggregates the cost and expense data by geographical location. A user may search and query combinations of cost and expense parameters over time to derive a cost and expense analysis of one or more geographical locations.

It will be appreciated that the benchmarking application 102 may parse and aggregate information contained in other datasets, including, but not limited to, supplier or vendor data. Such data may be aggregated by geographical location. A user may search and query combinations of cost and expense parameters over time to derive a cost and expense analysis of one or more geographical locations. A user may search and query combinations of supplier and vendor parameters or parameters of other datasets over time to derive an analysis of one or more geographical locations over a period of time.

Certain aspects of oil and gas information, including, without limitation, any information identifying an individual well, operator, or owner, is highly confidential and proprietary in nature. The benchmarking system 100 secures any such confidential and proprietary information stored in the database 114 and prevents users, outside of the owner of the information and other authorized parties, from accessing the information from the database 114.

In one implementation, the benchmarking application 102 analyzes the production and revenue data, the cost and expense data, and/or other datasets to remove proprietary or otherwise confidential information. Specifically, the benchmarking application 102 scrubs information relating to individual wells, operators, owners, or other confidential information from the production and revenue data, the cost and expense data, and/or other data. The datasets may be scrubbed and anonymized prior to, during, or after aggregation. Thus, the benchmarking application 102 collects anonymized production and revenue data, anonymized cost and expense data, and/or other anonymized data for one or more geographical locations over a given time period or according to other parameters.

The benchmarking application 102 combines or otherwise correlates distinct aggregated datasets. In one implementation, the benchmarking application 102 correlates the aggregated production and revenue data, the aggregated cost and expense data, and/or other aggregated data (e.g., supplier and vendor data). Specifically, the benchmarking application 102 aggregates, correlates, or otherwise analyzes the anonymized data for one or more selected geographical locations over a selected time period using one or more parameters.

In one implementation, the user selects one or more geographic locations for which the benchmarking application 102 aggregates or correlates data, such as production and revenue data, cost and expense data, and/or supplier and vendor data. The geographic locations may be countries, regions, states, counties, basins, fields, or other geographical formations, features, or areas. The geographic locations may be selected from a set of available locations, which may be displayed on a user interface as a data tree, a drop down menu, a data input field, a visual map, or the like. The set of available locations includes geographic locations for which the benchmarking application 102 has data. In one implementation, geographical locations and jurisdictional boundaries are layered over a map for selection by the user. The layered locations and boundaries may provide visual cues regarding how many wells for which the benchmarking system 100 has data and the type of data available. For example, the layered locations and boundaries may be color coded based on the amount of wells that are included in the geographic location. In other words, a county having data for twenty producing wells would be displayed on the map as a different color than a county having data for four producing wells. Additionally, the layered locations and boundaries may be color coded based on the type of data included in the geographical location. Stated differently, a county having only production and revenue data may be displayed on the map as a different color than a county having both production and revenue data and cost and expense data.

The user may also select a date range for which to correlate or aggregate data for the selected location. The dates (e.g., month and year) may be selected from a set of available dates, which may be displayed on a user interface as a data tree, a drop down menu, a data input field, a visual calendar, or the like. In one implementation, the set of available dates corresponds to production dates for which the benchmarking application 102 has production and revenue data and/or cost and expense data for the selected geographical location.

The user selects one or more parameters for which to correlate or aggregate data. The parameters may include, for example, production and revenue parameters, cost and expense parameters, supplier and vendor parameters, and correlation parameters. The parameters may be selected from a set of available parameters, which may be displayed on a user interface as a data tree, a drop down menu, a data input field, or the like. Information may be aggregated, correlated, analyzed, and presented based on variety of combinations of the various available parameters.

For example, based on one or more selected production and revenue parameters, the benchmarking application 102 aggregates anonymized production and revenue data for one or more selected geographical locations over a selected time period. In one implementation, the set of available production and revenue parameters includes: section (one square mile); township (36 sections); range; number of wells; measure of quality of gas produced (average British Thermal Unit (BTU)); measure of quality of oil produced (average gravity); gross production (total volume of oil, gas, or other mineral produced over one month); product type (oil, gas, mineral, etc.); average unit price (average price paid for barrel of oil or MCF of gas); gross value (gross production multiplied by the average unit price); gross severance tax (state tax paid on the gross value); gross advalorem tax (county tax paid on the gross value); conservation tax (another state tax paid on the gross value); gross other taxes (other taxes paid, including municipal taxes); gross transportation fees (third party costs paid to transport the oil, gas, or mineral); gross gathering fees (costs paid to gather the oil, gas, or mineral in a central location for transportation); gross processing fee (costs paid to process the oil and gas to remove hydrocarbons and other extracts); gross other deductions; and gross net value (net revenue, calculated from the gross production average unit price, gross value less the gross taxes and gross deducts).

Based on one or more selected cost and expense parameters, the benchmarking application 102 aggregates anonymized cost and expense data for one or more selected geographical locations over a selected time period. In one implementation, the set of available cost and expense parameters includes: geological and geophysical costs/expenses (e.g., costs/expenses associated with 3D seismic data); lease and land acquisition costs/expenses (e.g., actual costs/expenses associated with acquiring leases, land, or other property rights); drilling costs/expenses (e.g., costs/expenses associated with physically drilling wells, trucks, drilling rigs, pipe, cement); completion costs/expenses; equipment costs/expenses; and operating costs/expenses (e.g., incurred on a monthly basis). As opposed to regularly (e.g., monthly) incurred costs/expenses, such as operating costs/expenses, drilling and completion costs/expenses represent capitalized investment costs.

Based on one or more selected supplier and vendor parameters, the benchmarking application 102 aggregates anonymized supplier and vendor data for one or more selected geographical locations over a selected time period. In one implementation, the set of available supplier and vendor parameters includes: vendor types (e.g., pipe, rig, labor); total vendors; total vendor spend; and vendor concentration by well spend. In some implementations, the benchmarking application 102 overlays wells to pipeline and gathering system maps and/or utilizes RSS feeds of Nymex pricing, futures, storage injections/withdraws, weather, and the like.

As discussed herein, production and revenue data and cost and expense data are conventionally stored separately. Accordingly, in addition to aggregating and anonymizing data, the benchmarking application 102 correlates datasets based on one or more correlation parameters. In one implementation, the benchmarking application 102 correlates production and revenue data with cost and expense data for one or more selected geographical locations over a selected time period. It will be appreciated that the production and revenue data and the cost and expense data may be aggregated according to production and revenue parameters and the cost and expense parameters in addition to being correlated based on correlation parameters.

In one implementation, the correlation parameters include operating margin per unit. To generate the operating margin per unit, the benchmarking application 102 correlates the datasets to provide total well counts for production and revenue and costs and expenses separated and combined by geographical location. Drilling, completion, and equipment costs by geographical location are aggregated as a baseline investment over time. The benchmarking application 102 combines operating expenses and geographical location net values (total production less tax and other deductions) to determine operating margins. Capital costs less the operating margins are aggregated to determine a payout and return on investment. The benchmarking application 102 combines the capital costs and production to determine the finding costs per unit of production by production type (e.g., $X to produce a barrel of oil). To determine lifting costs per unit type produced, the benchmarking application 102 aggregates operating expenses and production. The operating margin per unit is determined by combining the expense per unit produced with the price per unit sold. The benchmarking application 102 disseminates the aggregated, correlated, or otherwise analyzed data in variety of manners.

In some implementations, from the selection criteria (i.e., the selected geographical location(s), date range, and parameters), the benchmarking application 102 generates performance metrics for the selected geographical location(s) over a selected date range. Performance metrics may be various forms of reference points, including, but not limited to, averages, medians, etc. However, other benchmarks or performance metrics are contemplated.

The generated performance metrics trends may be presented in various manners, such as tables or graphs, or displayed for each performance metric over time for selected geographical areas. For example, performance metrics for each of the selected parameters may be displayed in a table column for each of the selected geographical locations and production dates. In one implementation, the user may save the selection criteria to easily return to the performance metrics generated from the selection criteria in the future.

In one implementation, the benchmarking application 102 may extrapolate future performance metrics from the aggregated and/or correlated data and past and current trends in performance metrics. In one implementation, the benchmarking application 102 generates projections and alerts using the aggregated and/or correlated data and generated performance metrics. The projections may be extrapolated based on past performance metrics and other public well information. Every well has a projected lifespan with generally the highest production points at the beginning of first production and as the hydrocarbon reserves come to the surface and sub-surface pressure is generally at its highest. Production declines over the lifespan of the well until production eventually ceases. Taking this information into account and without disclosing any confidential or proprietary information, the benchmarking application 102 generates a projected production and financial performance for one or more geographical locations over time.

The benchmarking application 102 may generate alerts for new activities or performance anomalies. In one implementation, the benchmarking application 102 may compare aggregated and/or correlated data for a group of properties to the performance metrics for adjacent or surrounding geographical locations to determine if the owner 106 or the operator 108 is suffering from a performance anomaly or other concern. The owner 106 or the operator 108 may retrieve data on the property from the database 114 or manually input the data for the comparison. The comparison may be displayed in various manners, such as a table, graph, etc. In one implementation, the owner 106 or the operator 108 may set preferences to generate alerts when the data for the well is within or outside of a certain percentage, value, or tolerance, of the performance metrics, in some implementations. Further, in another implementation, the user may set preferences to generate alerts when the performance metrics for a select geographic location changes beyond a defined threshold.

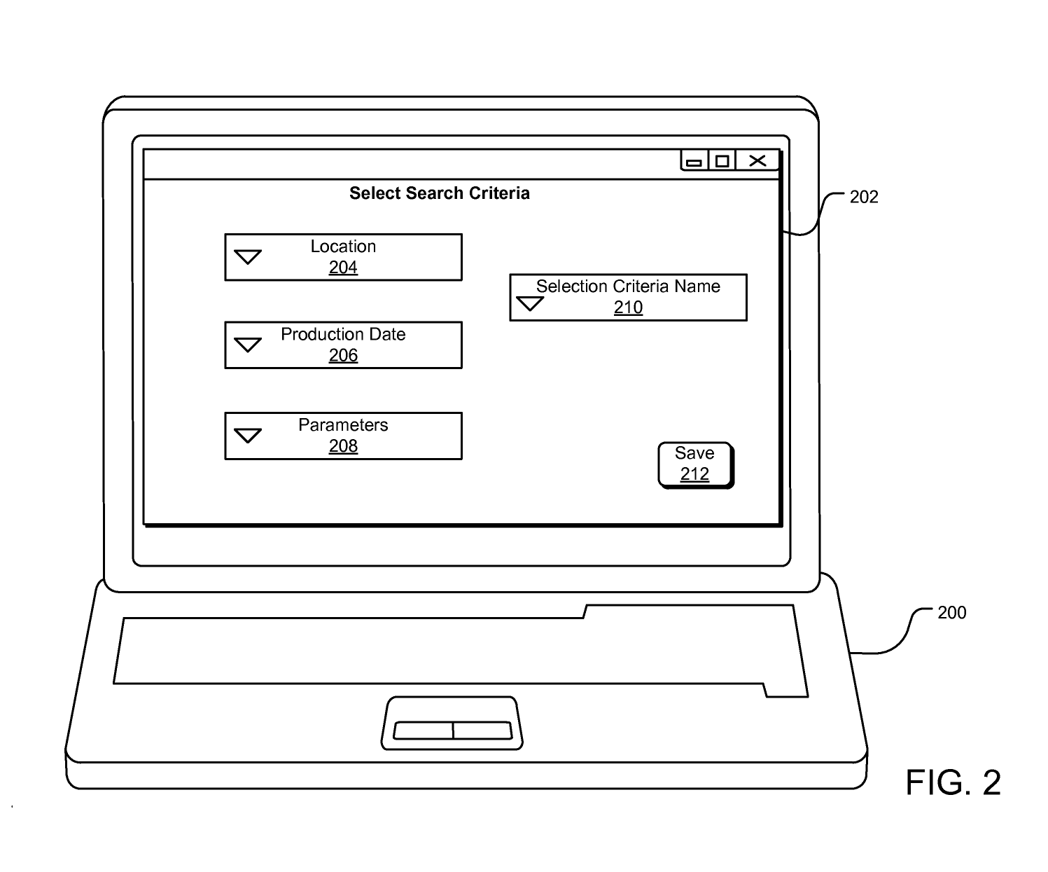

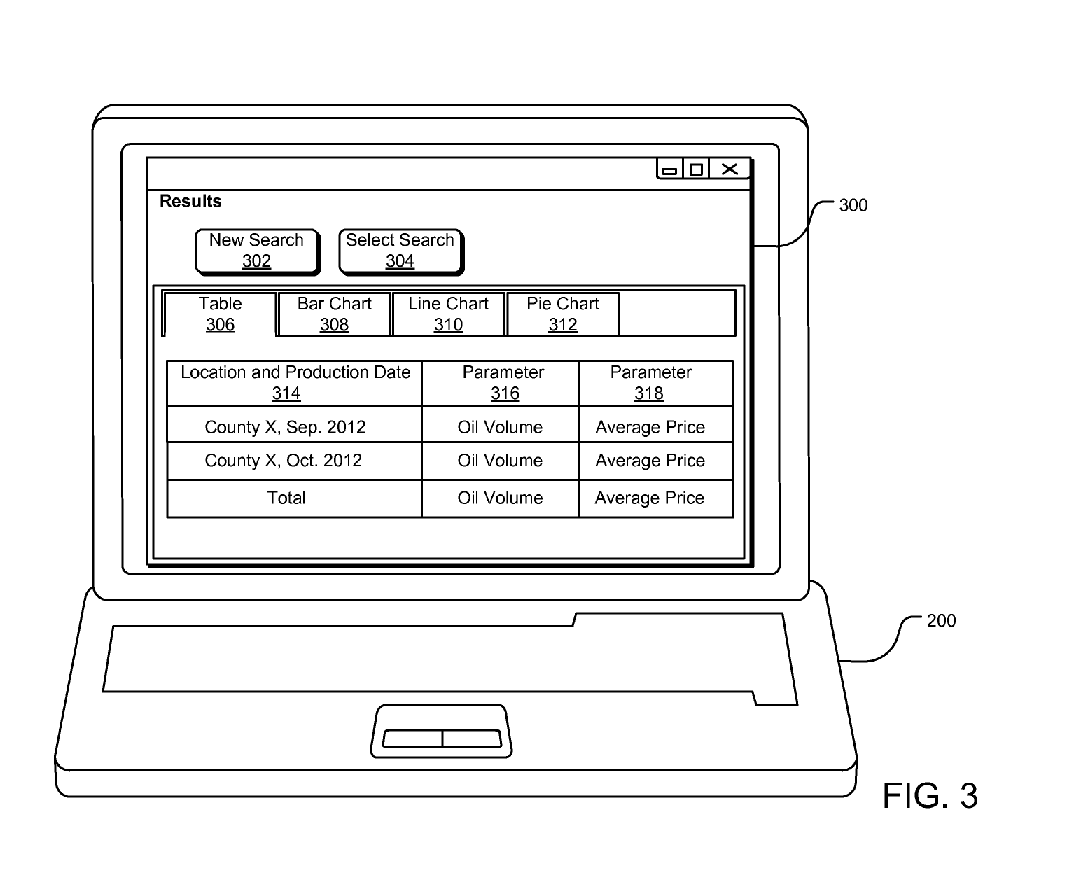

FIGS. 2-3 show an example user interface 200 through which access to and interactions with oil and gas aggregated and/or correlated data and performance metrics are controlled with the benchmarking application 102. It will be appreciated by those skilled in the art that such depictions are exemplary only and not intended to be limiting.

In one implementation, a subscriber accesses the benchmarking application 102 via a link in an interest account designed to manage revenue data exchange etc. (e.g., Oildex Owner Relations Connect (ORC), or Oildex Checkstub Connect (CDEX)). In another implementation, the subscriber connects directly to a homepage of the benchmarking application 102.

FIG. 2 shows an example user interface generated by the benchmarking application, the user interface 200 displaying a window for inputting or selecting search criteria 202. In the implementation shown in FIG. 2, the search criteria 202 includes a location drop-down menu 204, a production date drop-down menu 206, and parameters drop-down menu 208.

In one implementation, the user selects one or more geographic locations from the location drop-down menu 204. As described herein, the geographic locations may be countries, regions, states, counties, basins, fields, or other geographical formations, features, or areas. A production date range may be selected from the production date drop-down menu 206. The user may select one or more parameters with the parameters drop-down menu 208. As described herein, the set of available parameters may include: production and revenue parameters, cost and expense parameters, supplier and vendor parameters, and correlation parameters. A name of the selection criteria 202 may be entered in a selection criteria name field 210 and saved using a save button 212. Once the selection criteria 202 is input, aggregated and/or correlated data may be presented on the user interface 200 or otherwise disseminated to one or more users. In some implementations, the aggregated and/or correlated data is updated and disseminated automatically on a regular basis (e.g., monthly) to various users or subscribers.

In some implementations, once the selection criteria 202 is input, performance metrics 300 are generated and displayed on the user interface 200, as shown in FIG. 3. In the implementation shown in FIG. 3, the performance metrics 300 may be displayed in various formats, such as a table, a bar chart, a line chart, or a pie chart. The user may select or input new search criteria to generate new performance metrics using a new search button 302. In one implementation, selecting he new search button 302 directs the user to the search criteria 202. Alternatively, the user may return to previously generated performance metrics reports by selecting a select search button 304. In one implementation, selecting the select search button 304 directs the user to a window displaying a list of the previously generated reports from which the user may select a specific search.

In one implementation, when a table tab 306 is selected, a table of the performance metrics generated based on the information selected in the search criteria 202 is displayed. The table includes geographical location and production date data 314 and selected parameter data, including parameter 316 and parameter 318 are shown. In one implementation, the location and production date data 314 displays the selected geographical locations and production date range. Each geographical location is displayed for each date in the production date range. In the example shown in FIG. 3, if the user selects County X as the geographical location and September through October 2012 as the production date range, the location and production date data 314 displays the information in two rows as County X, September, 2012 and County X, October, 2012. The selected parameter data, including parameter 316 and parameter 318 are displayed as separate columns for each row. In one implementation, a total is calculated for each parameter and displayed in the table. Selecting a bar chart tab 308 displays the performance metrics 300 as a bar chart, selecting a line chart tab 310 displays the performance metrics 300 as a line chart, and selecting a pie chart tab 312 displays the performance metrics 300 as a pie chart.

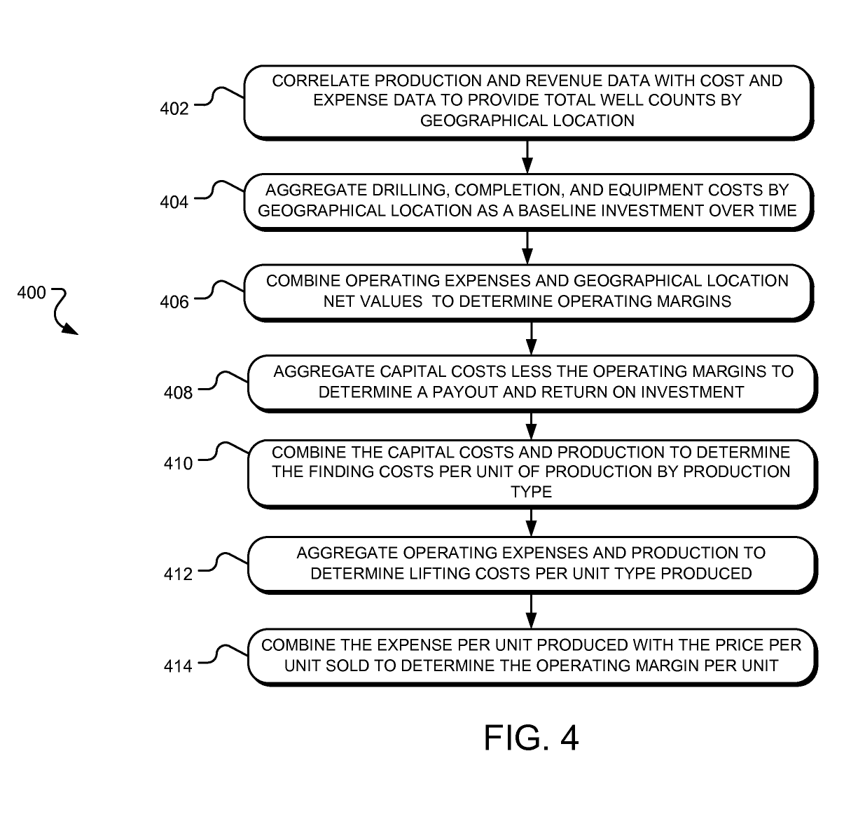

FIG. 4 illustrates example operations 400 for determining operating margins per unit using production and revenue data and cost and expense data. In one implementation, a correlating operation 402 correlates production and revenue data with cost and expense data to provide total well counts by geographical location. An aggregating operation 404 aggregates drilling, completion, and equipment costs by geographical location as a baseline investment over time. A combining operation 406 combines operating expenses and geographical location net values (total production less tax and other deductions) to determine operating margins. To determine a payout and return on investment, an aggregating operation 408 aggregates capital costs less the operating margins. A combining operation 410 combines the capital costs and production to determine the finding costs per unit of production by production type. To determine lifting costs per unit type produced, an aggregating operation 412 aggregates operating expenses and production. A combining operation 414 combines the expense per unit produced with the price per unit sold to determine the operating margin per unit.

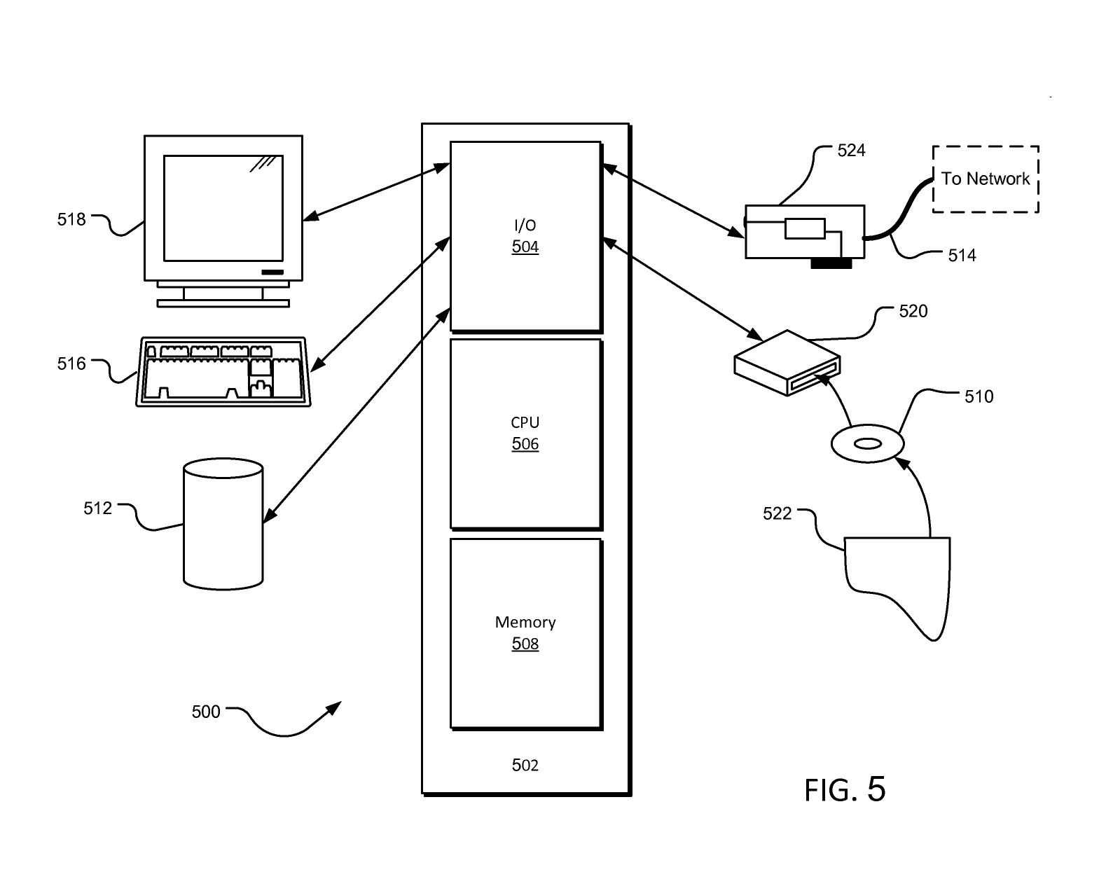

FIG. 5 is an example computing system 500 that may implement various systems and methods discussed herein. A general purpose computer system 500 is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer, such as one or more external computers made available via a cloud computing architecture. The presently described technology is optionally implemented in software devices loaded in memory 508, stored on a configured DVD/CD-ROM 510 or storage unit 512, and/or communicated via a wired or wireless network link 514, thereby transforming the computer system 500 in FIG. 5 to a special purpose machine for implementing the described operations.

The I/O section 504 is connected to one or more user-interface devices (e.g., a keyboard 516 and a display unit 518), a disc storage unit 512, and a disc drive unit 520. Generally, the disc drive unit 520 is a DVD/CD-ROM drive unit capable of reading the DVD/CD-ROM medium 510, which typically contains programs and data 522. Computer program products containing mechanisms to effectuate the systems and methods in accordance with the presently described technology may reside in the memory section 504, on a disc storage unit 512, on the DVD/CD-ROM medium 510 of the computer system 500, or on external storage devices made available via a cloud computing architecture with such computer program products, including one or more database management products, web server products, application server products, and/or other additional software components. Alternatively, a disc drive unit 520 may be replaced or supplemented by a floppy drive unit, a tape drive unit, or other storage medium drive unit. The network adapter 524 is capable of connecting the computer system 500 to a network via the network link 514, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are examples of communications devices for and other means of establishing a communications link between the computers may be used.

In an example implementation, production and revenue data, cost and expense data, aggregated data, correlated data, performance metrics, the benchmarking application 102, a plurality of internal and external databases (e.g., the database 114), source databases, and/or data cache on cloud servers are stored as the memory 508 or other storage systems, such as the disk storage unit 512 or the DVD/CD-ROM medium 510, and/or other external storage devices made available and accessible via a cloud computing architecture. Benchmarking software and other modules and services may be embodied by instructions stored on such storage systems and executed by the processor 502.

Some or all of the operations described herein may be performed by the processor 502. Further, local computing systems, remote data sources and/or services, and other associated logic represent firmware, hardware, and/or software configured to control operations of the benchmarking system 100. Such services may be implemented using a general purpose computer and specialized software (such as a server executing service software), a special purpose computing system and specialized software (such as a mobile device or network appliance executing service software), or other computing configurations. In addition, one or more functionalities of the benchmarking system 100 disclosed herein may be generated by the processor 502 and a user may interact with a Graphical User Interface (GUI) (e.g., the user interface 200) using one or more user-interface devices (e.g., the keyboard 516, the display unit 518, and the user devices 504) with some of the data in use directly coming from online sources and data stores. The system set forth in FIG. 5 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A computer system for analyzing oil and gas performance, the computer system comprising:
one or more databases configured to store revenue and production data corresponding to a plurality of producing wells;
a benchmarking application executable by at least one processor and configured to generate benchmarking information for a subset of the plurality of producing wells, the subset corresponding to one or more geographical locations, the benchmarking information including a plurality of values for at least one performance metric over a production date range, the at least one performance metric determined based on an anonymized dataset aggregated from the revenue and production data based on the subset; and
a graphical user interface executable by the at least one processor, the graphical user interface configured to display the benchmarking information.

2. The computer system of claim 1, wherein the benchmarking application is further configured to compare revenue and production data for at least one selected producing well to the benchmarking information.

3. The computer system of claim 1, wherein the one or more geographical locations include at least one of: one or more countries, one or more regions, one or more states, one or more counties, one or more basins, or one or more fields.

4. The computer system of claim 1, wherein the revenue and production data is obtained from a plurality of revenue exchanges over a network between one or more owners of the plurality of producing wells and one or more operators of the plurality of producing wells.

5. The computer system of claim 1, wherein the benchmarking information is at least one of an average or a median.

6. The computer system of claim 1, wherein the anonymized dataset is aggregated based on revenue and production parameters comprising at least one of: section of the subset; township of the subset; range; number of wells; measure of quality of gas produced; measure of quality of oil produced; gross production; product type; average unit price; gross value; gross severance tax; gross advalorem tax; conservation tax; gross other taxes; gross transportation fees; gross gathering fees; gross processing fee; gross other deductions; and gross net value.

7. A computer system for analyzing oil and gas performance, the computer system comprising:
one or more databases configured to store cost and expense data corresponding to a plurality of producing wells;
a benchmarking application executable by at least one processor and configured to generate benchmarking information for a subset of the plurality of producing wells, the subset corresponding to one or more geographical locations, the benchmarking information including a plurality of values for at least one performance metric over a production date range, the at least one performance metric determined based on an anonymized dataset aggregated from the cost and expense data based on the subset; and
a graphical user interface executable by the at least one processor, the graphical user interface configured to display the benchmarking information.

8. The computer system of claim 7, wherein the anonymized dataset is aggregated based on cost and expense parameters comprising at least one of: geological and geophysical costs/expenses; lease and land acquisition costs/expenses; drilling costs/expenses; completion costs/expenses; equipment costs/expenses; and operating costs/expenses.

9. The computer system of claim 7, wherein the benchmarking application is further configured to compare cost and expense data for at least one selected producing well to the benchmarking information.

10. A method for analyzing oil and gas performance, the method comprising:
receiving a dataset corresponding to a plurality of producing wells, the dataset including revenue and production data and expense and cost data;
storing the dataset in one or more databases;
aggregating the revenue and production data using at least one processor, the revenue and production data being aggregated for a subset of the plurality of producing wells, the subset corresponding to one or more geographical locations;
aggregating the cost and expense data using the at least one processor, the cost and expense data being aggregated for the subset of the plurality of producing wells;
anonymizing the aggregated revenue and production data and the aggregated cost and expense data using the at least one processor to remove proprietary and confidential information;
correlating the anonymized revenue and production data with the anonymized cost and expense data based on a production date range using the at least one processor; and
outputting the correlated data.

11. The method of claim 10, further comprising:
generating an operating margins using the at least one processor, the operating margins determined based on a combination of operating expenses and geographical location net values obtained from the correlated data, the geographical location net values determined based on a total production less deductions.

12. The method of claim 11, wherein the deductions include taxes corresponding to the subset of the plurality of producing wells.

13. The method of claim 11, further comprising:
generating a payout and return on investment using the at least one processor, the payout and return on investment determined based on capital costs obtained from the correlated data less the operating margins.

14. The method of claim 13, further comprising:
generating a finding costs per unit using the at least one processor, the finding costs per unit determined based on a combination of production values obtained from the correlated data and the capital costs.

15. The method of claim 11, further comprising:
generating a lifting costs per unit type produced using the at least one processor, the lifting costs per unit type produced determined based on a combination of production values obtained from the correlated data and the operating expenses.

16. The method of claim 10, further comprising:
generating an operating margins per unit using the at least one processor, the operating margins per unit determined based on a combination of an expense per unit produced and a price per unit sold obtained from the correlated data.

17. The method of claim 10, wherein the anonymized revenue and production data are further correlated with the anonymized cost and expense data based on revenue and production parameters comprising at least one of: section of the subset; township of the subset; range; number of wells; measure of quality of gas produced; measure of quality of oil produced; gross production; product type; average unit price; gross value; gross severance tax; gross advalorem tax; conservation tax; gross other taxes; gross transportation fees; gross gathering fees; gross processing fee; gross other deductions; and gross net value.

18. The method of claim 10, wherein the anonymized revenue and production data are further correlated with the anonymized cost and expense data based on cost and expense comprising at least one of: geological and geophysical costs/expenses; lease and land acquisition costs/expenses; drilling costs/expenses; completion costs/expenses; equipment costs/expenses; and operating costs/expenses.

19. The method of claim 10, further comprising:
generating a baseline investment over the production date range using the at least one processor, the baseline investment determined based on an aggregation of drilling, completion, and equipment costs obtained from the correlated data.

20. The method of claim 10, wherein the dataset is obtained from a plurality of revenue exchanges over a network between one or more owners of the plurality of producing wells and one or more operators of the plurality of producing wells.
